(19) United States
(12) Patent Application Publication
(10) Pub. No.: US 2004/0078261 A1
(43) Pub. Date: Apr. 22, 2004

(54) Automated vote counting

(76) Inventor: M. Susan Huhn Eustis, Lexington, MA (US)

Correspondence Address: FISH & RICHARDSON PC, 225 FRANKLIN ST, BOSTON, MA, 02110, US

(21) Appl. No.: 10/272,653

(22) Filed: Oct. 17, 2002

(51) Int. Cl. G06F 17/60

(52) U.S. Cl. 705/12

(57) ABSTRACT

A modular voting machine displays a portion of ballot across a number of distinct physical locations on the voting machine. A block of memory is allocated to each of the physical locations which display a portion of the ballot. The blocks of memory are configured by voting officials to associate the physical location on the voting machine with the portion of an actual ballot that is displayed at that physical location. Once the blocks of memory have been configured by voting officials, the information contained in the blocks of memory may be used by a processor to verify a voter's selection of a portion of the ballot displayed at the associated physical location. Once a voter complete his or her selections, the voting machine may record the votes in an internal, encapsulated memory device.

### TECHNICAL FIELD

This invention relates to automated vote counting.

### BACKGROUND OF THE INVENTION

Recent elections have highlighted the need for accurate, reliable, and inexpensive vote counting systems which are simple for a voter to use and for an election official to set up. Some current automated voting systems use machine-readable punch cards in which a voter punches out a “chad” on a punch card using a stylus to indicate his or her vote. The completed punch card is then fed through a machine which reads the punch cards and tabulates the votes. If a voter fails to completely punch out the “chad”, the card-reader machine may not be able to read the card and thus not count the vote. In close elections, these machine-rejected ballots may be examined by voting officials for evidence (e.g., a hanging or dimpled “chad” which has not been completely punched out) of the voter's intent. When the results of an election hinge on these machine-rejected votes, determination of voter's intent by voting officials examining punch cards can be a contentious and controversial issue. Accordingly it may be desirable to provide an inexpensive, tamper-resistant and easy-to-use automated voting machine to use in lieu of a punch-card system.

### SUMMARY OF THE INVENTION

In one aspect, the invention features a voting machine that includes a voter selection module which includes a plurality of distinct physical locations which each display a portion of a ballot and a also includes a plurality of input devices, at least one such device associated with each physical location. The voter selection module also includes a memory device which is configured with a plurality of blocks of memory, each block of memory mapped to a separate physical location, wherein each block of memory contain data which indicate information about the portion of a ballot located at the corresponding physical location, such as whether the portion of the ballot at the corresponding physical location contains the name of a candidate.

Embodiments may include one or more of the following features. The input devices may be devices such as a surface having a plurality of electrostatic points or buttons. The voting machine may include a number of hot-swappable voter selection modules.

The voting machine may also include a processor removably connected to the voter selection module and configured to receive input from one or more the plurality of input devices indicating a voter selection and read the data located at the block of memory associated with the selected physical location to verity validity of the selection. The processor may include one or more CPU and a storage device.

The voter selection module of the voting machine may include an indicator light associated with each physical location such that the indicator light illuminates when the input device associated with that physical location is selected and the processor has verified the validity of the selection.

The voting machine may further include one or more input devices, such as a touch screen or a display and keyboard, which are configured to permit a user to set one or more bits in each block of memory according to a portion of a ballot displayed at the corresponding physical location. The user may set one or more bits in each block of memory via a graphical user interface presented on the display.

The voter selection module further comprises a ballot card holder configured to hold a paper ballot card or may include one or more displays configured to electronically display a ballot.

The voting machine may also include a printer, electrostatic input device configured to record images of write-in votes, or second input device configured to cause the processor to record a voter's selections when the processor receives a signal from the second input device.

The processor and memory device may be encapsulated in a container. The voting machine may also include a main power supply (e.g., an AC/DC converter) and a back-up power supply (e.g., a battery) configured to provide electrical power to the voting machine in the event of a failure of the main power supply.

The voting machine may also include a communications device in communication with a remote election control panel where information may be downloaded to or uploaded from the remote control panel.

In another aspect, the invention features a method of automated vote counting comprising the steps of providing a ballot, providing a plurality of vote selection devices within a voting terminal, providing a processor, the processor having a central processing unit and a storage device having a memory; and associating each one of the plurality of vote selection devices with a unique physical location on the ballot and a unique block of memory within the storage device, each associated vote selection device, physical location on the ballot and block of memory forming a candidate space location, and wherein the blocks of memory include a plurality of bits which hold information about their respective candidate space locations.

Embodiments may include one or more of the following features. The method may also include steps of receiving a vote selection from an input device by a user, identifying the input device from which the vote selection was received, and validating the user's selection by reading one or more of the blocks of memory associated with the vote selection device from which the vote selection was received.

The method may include determining if the user's selection is for a write in candidate and receiving a write in vote from the input device if the user's selection is for a write in candidate. The method may also include receiving input from the user indicating completion of the voting process and, in response, recording all of the user's selections as votes within the storage device and printing out the user's finalized votes.

In another aspect, the invention features a method for method for automated vote counting including the steps of associating a physical location on a voting machine with a block of memory, wherein the physical location on the voting machine is configured to display ballot information, and assigning a definition to one or more bits within the block of memory such that the one or more bits indicate data about ballot information displayed at the associated physical location on the voting machine.

Embodiments of the invention may include one or more of the following features. The step of assigning a definition may further include a step of defining one bit within the block of memory to indicate whether the ballot information located at the associated physical location contains a candidate's name. The ballot may be electronically displayed by the voting machine or it may be displayed as a paper ballot.

The method may further include a step of displaying ballot information in the physical location of the voting machine, and setting one or more bits within the block of memory according to the ballot information located at the associated physical location.

The method may include the step of associating a first set of physical locations on a first voting module with a separate block of memory, wherein each physical location on the first voting module is configured to display a portion of ballot of information and associating a second set of physical locations on a second voting module with a separate block of memory, wherein each physical location on the second voting module is configured to display a portion of ballot of information. Additionally, the method may include steps of detecting a failure in one of the voting modules and replacing the failed voting module with a third voting module without rebooting the voting machine.

The method may also include steps of associating a physical location on the voting module with a selection device and receiving an input from a selection device associated with the physical location, wherein the input indicates a voter has made a selection based on the ballot information displayed at the associated physical location. The method may also verify the validity of the voter's selection, illuminate an indicator light indicating a valid selection, and record the voter's selections as votes upon an input indicating that the voter has completed the voting process. The method may also include a step of printing out the voter's selections.

The method may also include steps of receiving and storing voter information, such as political party information, and using the voter information to further validate voter selections.

The details of one or more embodiments of the invention are set forth in the accompanying drawings and the description below. Other features, objects, and advantages of the invention will be apparent from the description and drawings, and from the claims.

### BRIEF DESCRIPTION OF THE SEVERAL VIEWS OF THE DRAWING

FIG. 1 is a block diagram of a voting machine.

FIG. 2 is a block diagram of a voting module.

FIG. 3 is a block diagram of several interconnected components of a voting machine.

FIG. 4 is a map of a block of bits assigned to a candidate space location.

FIG. 5 is a diagram of a printed ballot card installed beside a voting module.

FIG. 6 is a flow chart of the algorithm the set-up program runs when a voter presses a button on a voting module.

FIG. 7 is a diagram of another voter selection module.

### DETAILED DESCRIPTION

The following detailed description describes a modular voting machine having hot-swappable electronic modules so that if a component fails, the module containing the failed component may be replaced without loss of counted votes. Additionally, the voting machine is configured using a set up process described below rather than by traditional software programming. The set up process is used to configure the voting machine for a particular election by one or more technicians who push buttons on a touch-screen or other input device to input data about the portion of the ballot that appears at a particular physical location on the voting machine. In operation, a voter may select an input device, such as a button, associated with a physical area on the voting machine which displays a portion of a ballot (e.g., a candidate's name). In response to a voter's selection, the voting machine can automatically verify the validity of a voter's selection by reading the set up information associated with the physical location selected by the voter. Moreover, vote counting occurs in a secure, tamper-resistant environment because the actual vote counting occurs in an embedded system that has been encapsulated at the factory before the voting machine is shipped and is inaccessible to local voting officials and technicians.

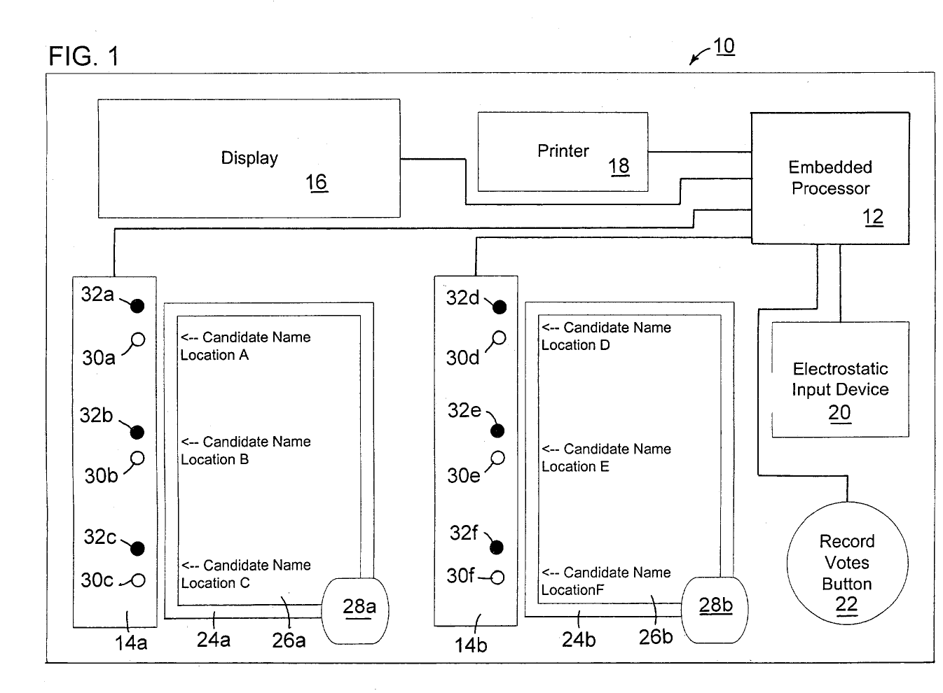

As shown in FIG. 1, a voting machine 10 includes an embedded processor 12 which executes an operating system (not shown) is connected to two voting modules 14a-14b, a touch-screen display 16, a printer 18, an electrostatic input device 20, and a record votes button 22. Additionally, a ballot card holder 24a-24b is located next to each of the voting modules 14a-14b. Each ballot card holder 24a-24b holds a printed ballot card 26a-26b. After a printed ballot card 26a-26b is placed in a ballot card holder 24a-24b, a seal 28a-28b is placed on an edge of each ballot card holder 24a-24b in order to prevent tampering with the printed ballot card 26a-26b.

Each voting module 14a-14b includes a number of voting buttons (30a-30c and 30d-30f) and corresponding indicator lights (32a-32c and 32d-32f). When an active voting button is selected, the corresponding indicator light will illuminate to indicate a valid selection. Similarly, if a voter changes his or her vote and deselects an active button by pressing the button a second time, the corresponding indicator light is shut off.

Each voting button and corresponding indicator light is associated with a candidate name location (e.g., “Candidate Name Location A” in FIG. 1) within each ballot card holder 24a-24b by the embedded processor 12. Each candidate name location corresponds to an actual physical location on the voting module where a portion of a ballot is displayed. The combination of a candidate name location and the associated vote selection button (30a-30c and 30d-30f) and indicator light (32a-32c and 32d-32f) make up a candidate space location. As will be described in greater detail later, each candidate space location is assigned a permanent address location in the memory of the embedded processor 12 that stays the same election after election, even though the names of the candidates presented in a particular candidate name location on the printed ballot card changes from one election to the next.

The voting machine 10 supports hot-swapping of electronic components should a component (e.g., voting module 14a-14b, touch-screen display 16, printer 18, electrostatic input device 22) or a part of a component (e.g., a voting button 30a-30f or indicator light 32a-32f) fail during the election. A hot-swappable component is one in which may be added or removed from the voting machine while the voting machine is running and have the operating system automatically recognize the change

Voting machine 10 also includes a touch-screen display 16 which, as will be described in greater detail below, is used by voting officials to configure the voting machine for a particular election. In addition, the touch-screen display 16 may be used during the election process by voting officials to view cumulative vote totals before the polls open (which should read zero for each candidate location) and throughout the voting process. In other separate embodiments, the voting machine may include one or more displays to display the ballot in lieu or in addition to the printed ballot cards. If one or more displays electronically displays the ballot, the voting machine may be configured to permit a voter to change the language of the ballot presented on the display.

Additionally, a printer 18 is included within voting machine 10 which may be used to print a voting receipt for each voter after he or she presses the record votes button 22. The printer 18 may also be used by voting officials to print election results during and after the voting process. While the touch-screen display 16 and printer 18 are shown to be integrated within the voting machine 10 in FIG. 1, in other separate embodiments one or both of these devices could be external to the voting machine and connected via cable or a wireless modem.

An electrostatic input device 20 functions as a write-in mechanism for voting machine 10 and is connected to the embedded processor 12. If a voter elects to write-in a candidate, he or she may do so by writing the person's name on the electrostatic input device 20 with a stylus. The electrostatic input device 20 records an image of the name of the candidate written in by the voter which will be later printed out and hand-counted by election officials. In a separate embodiment, text-recognition software may be included in embedded processor 12 in order to convert the hand written image into ASCII character text. Additionally, the write-in mechanism need not be an electrostatic input device, but could also be other electronic input devices commonly known such as a keyboard or a touch-screen.

In another embodiment, a printer (e.g., printer 16 shown in FIG. 1) may function as a write-in device. In this embodiment, when a voter indicates a desire to write-in a candidate, the printer prints out the candidate space location on a piece of paper. The voter then writes in his or her candidate for that office and deposits the write-in vote in a box within the polling station.

A record votes button 22 connected to the embedded processor 12 is also provided within voting machine 10. After a voter has completed his or her selections, he or she may press the record votes button 22 to record the votes and finalize the voting process for that voter. When the voter presses the record votes button 22, the printer 18 prints out a hardcopy of the voter's selections, including any write-in candidates. The voter then takes the hardcopy of his or her votes and places it in a box before leaving the polls. By having a printer 18 print out a hardcopy of the voters' selections, it helps to assure the voter to that his or her votes were successfully recorded and also functions to provide an audit trail of the results. While the record votes button shown in FIG. 1 is an actual button on the voting machine 10, in other embodiments a record votes function may be performed by other operations such as opening a curtain, activating a switch, or pulling a handle.

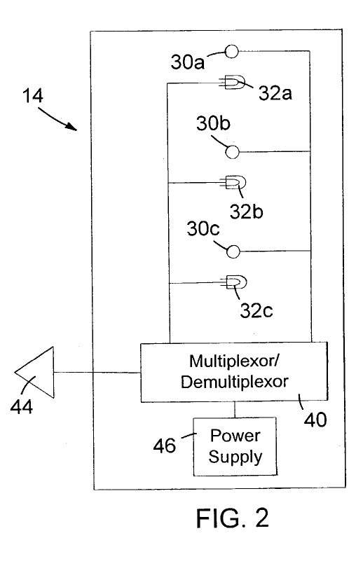

As shown in FIG. 2, a voting module 14 includes three voting buttons 30a-30c and corresponding indicator lights 32a-32c. The voting module 14 also includes a power supply 46 (e.g., a lithium battery), which provides back up power to the module in the event of a failure of the main power supply of voting system 10 (shown in FIG. 1).

The voting module 14 also includes a multiplexor/demultiplexor 40 with is connected to each of the voting buttons 30a-30c and indicator lights 32a-32c. The multiplexor/demultiplexor 40 is also connected to an interconnection device 44 (e.g., a plug). When module 14 is inserted into the voting machine 10, the interconnection device 44 connects with a mating interconnection device (not shown) in voting machine 10 in order to establish a communication channel between module 14 and the embedded processor 12.

When one of the voting buttons 30a-30c is selected, the multiplexor/demultiplexor 40 senses which of the three buttons was selected and transmits that information to the embedded processor. As will be described in greater detail below, the embedded processor determines whether the button selected by the voter is a proper selection. If it is, then the embedded processor sends a signal back to the multiplexor/demultiplexor 40 indicating a proper selection and the multiplexor/demultiplexor 40, in turn, illuminates the corresponding indicator light. If the embedded processor determines that the button selected by the voter is not a proper selection, then no signal will be sent to the multiplexor/demultiplexor 40 instructing an illumination of an indicator light.

Like the other components of voting machine 10 (e.g., the display 16, printer 18, electrostatic input device 20), the voting module 14 is a hot-swappable component of the voting machine 10 (shown in FIG. 1). The voting buttons 30a-30c and vote selection lights 32a-32c are monitored by the embedded processor in order to detect a failure of a voting button or indicator light. After each voter presses the record votes button 22, the embedded processor runs a systems check on each of the voting buttons 30a-30c, indicator lights 32a-32c, and other components such as the printer, display and write-in mechanism to ensure that the voting machine 10 is functioning properly. If embedded processor 12 detects a failure of a voting button 30a-30c, indicator light 32a-32c, or other component, the embedded processor 12 prevents further voting until the component containing the failed sub-component is replaced or repaired. If the systems check run by embedded processor 12 indicates that all components are functioning properly, the voting machine 10 permits voting by the next voter.

In a separate embodiment of voting module 14, a separate multiplexor and demultiplexor may be used, the multiplexor dedicated to sensing which buttons have been selected and relaying the information to the embedded processor, and the separate demultiplexor dedicated to receiving control signals from the embedded processor to illuminate indicator lights.

In yet another embodiment of voting module 14, the voting buttons and corresponding indicator lights may be connected directly to the embedded processor over an interconnection device and with a multiplexor/demultiplexor located within embedded processor.

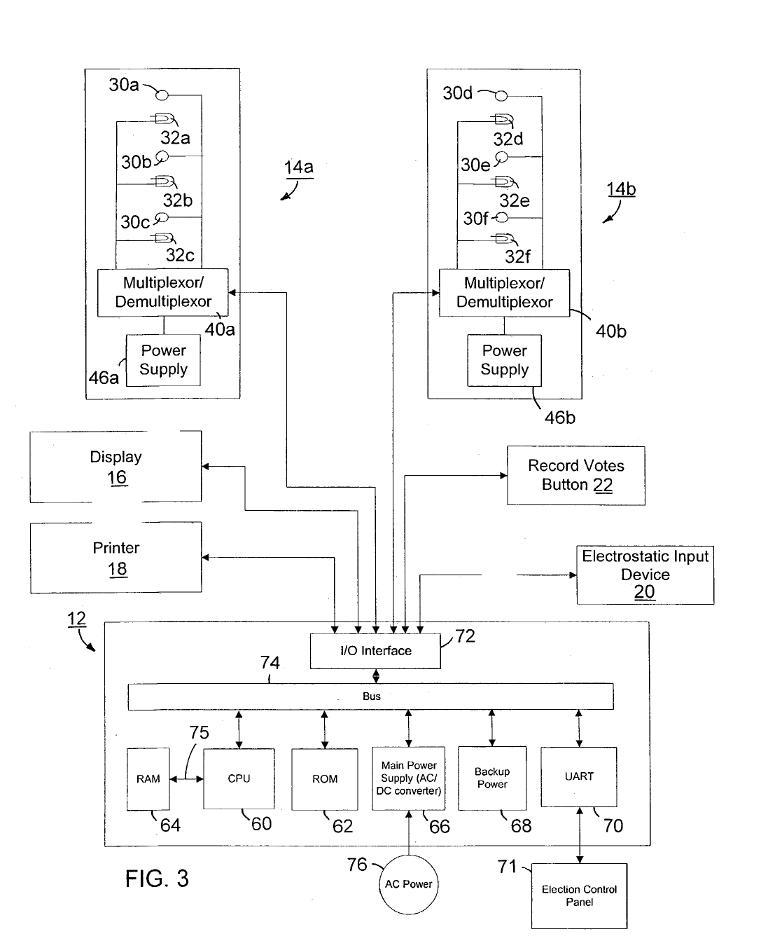

As shown in FIG. 3, the embedded processor 12 of voting machine 10 (shown in FIG. 1) includes a central processing unit (CPU) 60, Read-Only Memory (ROM) 62, Random Access Memory (RAM) 64, a power supply 66, a back up power supply 68, a Universal Asynchronous Receiver Transmitter (UART) 70, and an input/output device 72 interconnected across a bus 74. Embedded processor 12 is fully encapsulated in a tamper-resistant package, such as a molded plastic case that surrounds the embedded processor.

As will be explained in greater detail below, the ROM 62 contains the set-up routine which may be part of the operating system of the voting machine or may be a separate program. The set-up routine is used by officials use to set-up the parameters of the particular election before the election and validates and records the voter's selections during the voting process. ROM 62 also contains driver information for the peripheral devices (e.g., the display 16, printer 18, voting modules 14, electrostatic input device 22 and record votes button 22) of the voting machine 10. While ROM 62 contains the set-up program, RAM 64 stores the parameters selected by the voting officials through the set-up program before the election. RAM 64 is interconnected to the CPU 60 via a separate memory bus 75.

While ROM 62 and RAM 64 are illustrated in FIG. 3 as storage devices for the embedded processor, many other storage devices may be used in lieu of or in addition to ROM 62 or RAM 64, such as a hard-drive, floppy disk drive, removable disk drive, Electronically Programmable Read Only Memory device (EPROM), an Erasable Electronically Programmable Read Only Memory device (EEPROM), or one or more registers.

Power supply 66 is an AC-DC converter which plugs into an AC power source 76 (e.g., a wall socket) and delivers DC power to the embedded processor and the peripherals of the voting machine (i.e., the voting modules, the printer, and the display). Backup power supply 68 is a lithium battery located within embedded processor 12 which provides DC power in the event of a power failure of power supply 66. In another embodiment, a backup power supply may be located wholly or partially outside the embedded processor. Additionally, other embodiments may include additional back up power supplies, such as a car battery, a fuel cell, or a gas-powered generator to provide longer-term backup power in the event of a power outage.

UART 70 is included within embedded processor 12 and connects to an election control panel 71. Vote tallies are downloaded from the voting machine 10 to the election control panel 71 via UART 70 after each voter completes his or her ballot. The election control panel includes a storage device which stores the vote totals. This permits voting officials to monitor the election results on a real-time basis. In addition, storing the vote totals on the election control panel provides a back-up storage system for the vote totals. Thus, if RAM 64 of the voting machine 10 should become erased or corrupted during the voting process, vote totals for the voting machine would still be preserved.

In addition to downloading vote totals to an election control panel 71, UART 70 may also upload information from the election control panel 71 to the voting machine 10 during the election. For example, voting officials may upload voter information such as political party registration and voting restrictions via the UART 70. This voter information may be used by embedded processor 12 to validate voter selections. Additionally, if embedded processor 12 should fail during the election, voting officials may replace it with a functional embedded processor. Rather than setting up the new embedded processor, voting officials may upload set up information and vote totals that had been saved from the previous embedded processor via the UART 70. This permits voting officials to quickly and easily replace a faulty embedded processor during the election.

The election control panel 71 may include a public counter, which may be viewed by election officials during the election, as well as a protected counter which cannot be accessed without a password. Additionally, the election control panel 71 may include the capability to electronically lock and unlock voting machine 10 at the beginning and end of the voting period.

Embedded processor 12 is also connected to printer 16, display 18, the electrostatic input device 20, and the record votes button 22. All of these components (i.e., the printer 16, display 18, electrostatic input device 20, and record votes button 22) are hot-swappable components that may be replaced during an election should one or more fail.

In another embodiment, the voting machine 10 may include a second embedded processor in order to eliminate some of the computational burden on a single CPU. For example, a second processor may be used to perform print driving functions, and refresh for the selection indications.

The voting machine 10 is configured for a particular election through a set-up program stored in ROM 62. Voting officials use the set up routine configure each candidate space location according to information on the printed ballot card for a particular election. Once the set-up information is loaded, it may be used to validate voter's selections and record the votes.

Embedded processor 12 associates a number of bits at a permanent address location within RAM 64 (shown in FIG. 3) for each candidate space location within the voting machine 10. Voting officials configure the candidate space locations by enabling various bits that are assigned to each candidate space location.

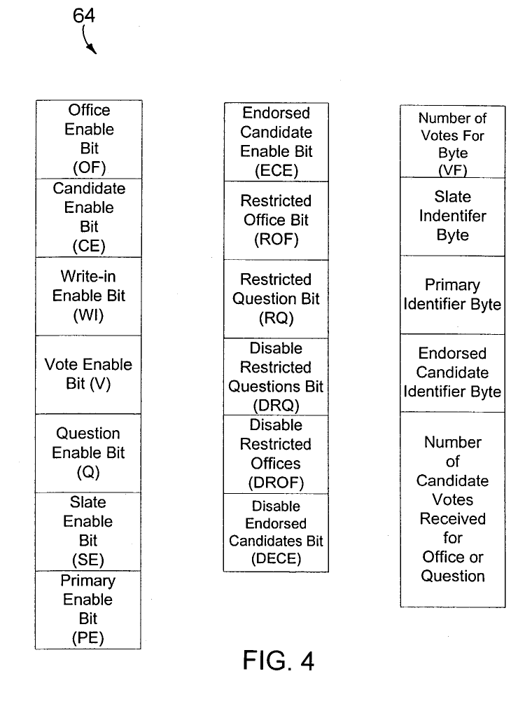

As shown in FIG. 4, a block of sixty (60) bits of RAM 64 is assigned to each candidate space location (e.g., “Candidate Space Location A” shown in FIG. 1) in a voting machine. These blocks of sixty bits are used to store the set up information input by voting officials, the choices voters make during the voting process, and the accumulated vote totals for each candidate space location. In this embodiment, the block of sixty bits for each candidate location is assigned the definitions shown in Table I.

TABLE I

| Bit | Name | Definition |
|---|---|---|
| 0 | Office Enable Bit (OF) | Indicates whether the candidate space location is the start of |
| | | an office or question field on the printed ballot card. All of |
| | | the candidate space locations associated with a particular |
| | | office or question on the printed ballot card are defined as a |
| | | candidate field or, in the case of a question, a question field. |
| 1 | Candidate Enable bit | Indicates whether the candidate space location is associated |
| | (CE) | with a candidate on the printed ballot card. If this bit is set, |
| | | then the voting button and indicator light associated with this |
| | | candidate space location will be active during the voting |
| | | process. |
| 2 | Write-In Enable bit | Indicates whether the candidate space location is associated |
| | (WI) | with a selection to write in a candidate. |
| 3 | Vote Enable bit (V) | Indicates whether the candidate space location has been |
| | | selected by the voter. |
| 4 | Question Enable bit | Indicates whether the candidate space location is associated |
| | (Q) | with a response to a question presented to a voter (e.g., “yes” |
| | | or “no”). If this bit is set, then the voting button and |
| | | indicator light associated with this candidate space location |
| | | will be active during the voting process. |
| 5 | Slate Enable bit (SE) | Indicates whether the candidate space location is associated |
| | | with a vote for an entire slate of candidates. For example, |
| | | this feature may be used to permit a voter to press a single |
| | | button to automatically select all democratic or republican |
| | | candidates for all offices having a democratic or republican |
| | | candidate. |
| 6 | Primary Enable bit | Indicates whether the candidate space location is associated |
| | (PE) | with a primary election where only a portion of the |
| | | candidates presented can be selected at any one time. For |
| | | example, in a primary election registered democrats may only |
| | | vote for democratic candidates and registered republicans |
| | | may vote for republican candidates. In many states |
| | | independents may choose a party in secret in the booth, but |
| | | then are locked out from the other parties. |
| 7 | Endorsed Candidate | Indicates whether the candidate space location is associated |
| | Enable bit (ECE) | with a selection for one or more endorsed candidate. For |
| | | example, this feature may be used to permit a voter to press a |
| | | single button to automatically select all candidates who have |
| | | received a particular endorsement with one button or switch. |
| 8 | Restricted office bit | Indicates whether the candidate space location is associated |
| | (ROF) | with a restricted office election in a particular election. For |
| | | example, a restricted office election may happen when a |
| | | voter lives in a school district but outside a municipality; this |
| | | voter may be able to vote for school committee candidates, |
| | | but may not vote for municipal offices. |
| 9 | Restricted Question bit | Indicates whether the candidate space location is associated |
| | (RQ) | with a restricted question in a particular election. For |
| | | example, a restricted question may happen when a voter is |
| | | able to vote on a particular question or issue, e.g., a school |
| | | bond issue, but not for candidates for office. |
| 10 | Disable Restricted | Prohibits the setting of any restricted questions in a particular |
| | Question bit (DRQ) | election. |
| 11 | Disable Restricted | Prohibits the setting of any restricted offices in a particular |
| | Office bit (DROF) | election. |
| 12 | Disable Endorsed | Prohibits the setting of any endorsed candidates in a |
| | Candidate bit (DECC) | particular election. |
| 13-20 | Number of Votes For | Indicates the maximum number of candidates a voter may |
| | byte (VF) | select for a particular office or question field. For example, if |
| | | the voter may only vote for one candidate for the particular |
| | | office, then these bits may be set to 0000 0001. If the voter |
| | | may vote for two candidates for a particular office, then the |
| | | bits may be set to 0000 0010. |
| 21-28 | Slate Identifier byte | This byte associates the candidate location space with a |
| | | particular slate of candidates. For example, a 0000 0001 in |
| | | this location may indicate the candidate is a Republican, a |
| | | 0000 00010 may indicate a Democrat, a 0000 00011 may |
| | | indicate Libertarian, and so on. If the slate enable bit is |
| | | enabled, a voter may be able to vote for all Republicans, |
| | | Democrats, Libertarians, etc. in each office up for election by |
| | | selecting a single switch or button. |
| 29-36 | Primary Identifier byte | This byte associates the candidate space location with a |
| | | particular political party that has candidates running against |
| | | each other in a primary election. If the primary enable bit is |
| | | enabled, a voter is restricted to vote for only candidates |
| | | associated with the voter's registered political party. Or, in |
| | | some states, independent voters may choose which political |
| | | party primary to participate in while in the voting booth, but |
| | | becomes blocked out of other party's primaries once the |
| | | voters makes a selection. |
| 37-44 | Endorsed Candidate | This byte associates the candidate space location with a |
| | Identifier byte | particular endorsement. If the endorsed candidate enable bit |
| | | is enabled, the candidate space location is linked to one or |
| | | more other candidates on the ballot by assigning each of the |
| | | candidates the same value in this byte. A voter may thus |
| | | select a group of candidates associated with a particular |
| | | endorsement by selecting a single button or switch. |
| 45-60 | Number of Candidate | These two bytes hold the cumulative count of votes for the |
| | Votes bytes | candidate space location during a particular election. |

The block of bits illustrated in FIG. 4 and described in Table I permits the voting machine 10 to be adapted to different requirements of the various states' and countries' voting laws. Various embodiments may include fewer of the set up bits to provide a simpler, but less versatile system, or additional bits to increase versatility.

In addition to storing the set up information for each candidate space location, a portion of RAM 64 is reserved to store voter information such as the voter's political party affiliation (which may be used to restrict the voter's ability to vote for candidates associated with other political parties in a primary election) or voter restrictions (which may be used to restrict the voter to only certain items on the ballot). A voting official enters the voter information externally via an election control panel 71 and uploads it to the voting machine 10 via UART 70. Alternatively, the voting official may enter the voter information through an input device (e.g., the touch-screen display 18) directly connected to embedded processor 12.

A voting official will set the appropriate bits for each candidate space location according to the information on the printed ballot card 26a-26b (shown in FIG. 1). In practice, a voting official may insert a printed ballot card into the ballot card holder and then set the appropriate bits for each candidate space location. Voting officials may access to set up routine to set the bits through a variety of interfaces commonly used, including a graphical user interface presented on a touch screen display (as illustrated in FIG. 1) or a display in combination with a keyboard, mouse, trackball, touchpad, or the like either integrated within or external to the voting machine.

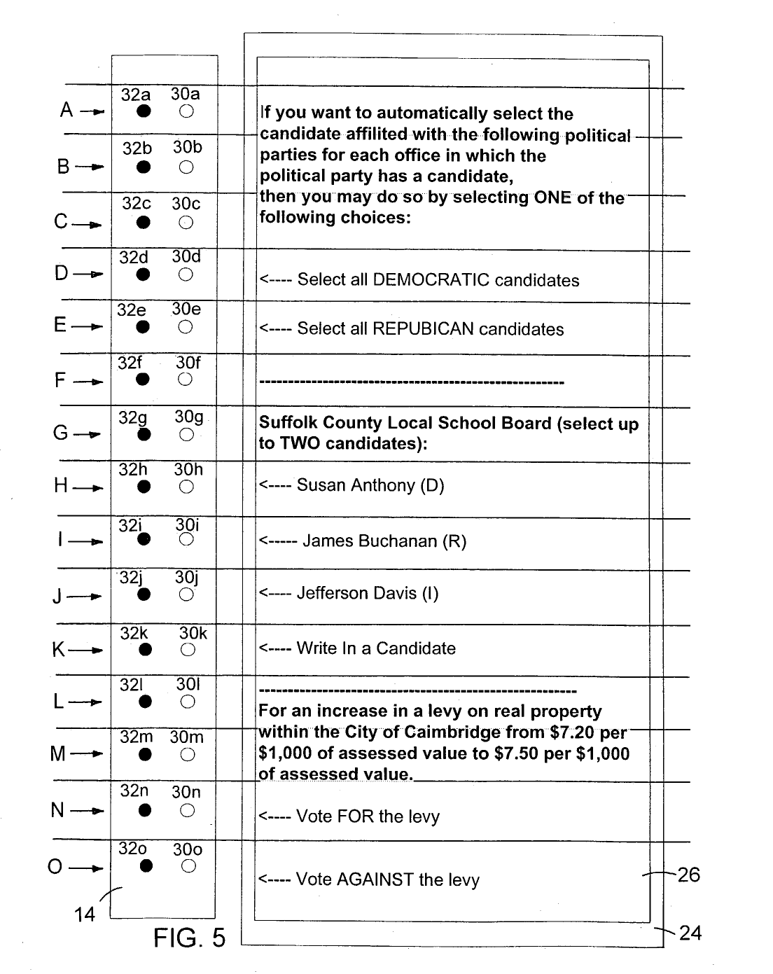

To illustrate how a voting official might use this technique, FIG. 5 shows a printed ballot card 28 inserted into a ballot card holder 24 in a voting machine 10. In this embodiment, a voting machine includes a voting module 14 which has fifteen (15) sets of voting buttons 30a-30o and corresponding indicator lights 32a-32o. The fifteen buttons and indicator lights provided on voting module 14 signify fifteen candidate space locations labeled A-O. Each candidate space location A-O is assigned a block of sixty (60) bits in RAM within the embedded processor of the voting machine. The blocks of sixty bits assigned to each candidate space location are defined in accordance with FIG. 4 and Table I.

The printed ballot card 26 contains two issues for a voters' consideration. First, voters may select two candidates for a local school board election and second, voters may vote on whether or not to raise a levy on real property taxes. Additionally, the printed ballot card permits voters to select all of the Democratic or Republican party candidates running for office with a single selection. Prior to the election, a voting official would place the printed ballot card 26 into the ballot card holder 24 on the voting machine 10 and then, through a graphical user interface, set the bits shown in Table II for each candidate space location.

TABLE II

| Candidate | |
|---|---|
| Space | |
| Location | Bits Set (all other bits set to zero initially) |
| A | OF = 1, indicating the start of an office or question on the ballot card; |
| | VF = 0000 0001, indicating that only one selection may be made for this office or |
| | question on the ballot card; |
| B | No bits enabled indicating a blank space or continuation from a previous line on the |
| | printed ballot card. |
| C | No bits enabled indicating a blank space or continuation from a previous line on the |
| | printed ballot card. |
| D | Q = 1, indicating that this candidate space location is associated with a response to a |
| | question that the voter may select (i.e., select all democratic candidates). Setting this |
| | bit also means that the button and indicator light associated with this candidate space |
| | location is active, that is able to be selected by voters during the election. |
| | SE = 1, indicating that this question on the ballot is associated with a vote for an |
| | entire slate of candidates. |
| | Slate Number = 0000 0001, indicating that this candidate space location is linked to |
| | all candidates sharing this same slate number. |
| E | Q = 1, indicating that this candidate space location is associated with a response to a |
| | question that the voter may select (i.e., select all republican candidates). Setting this |
| | bit also means that the button associated with this candidate space location is active, |
| | that is able to be selected by voters during the election. |
| | SE = 1, indicating that this question on the ballot is associated with a vote for an |
| | entire slate of candidates. |
| | Slate Number = 0000 00010, indicating that this candidate space location in linked to |
| | all candidates sharing this same slate number. |
| F | No bits enabled indicating a blank space or continuation from a previous line on the |
| | printed ballot card. |
| G | OF = 1, indicating the start of an office or a question on the printed ballot card. |
| | VF byte = 0000 0010, indicating that a voter may select up to two candidates for this |
| | office. |
| H | CE = 1, indicating that this candidate space location is associated with a candidate for |
| | office. Setting this bit also means that the button associated with this candidate space |
| | location is active, that is able to be selected by voters during the election. |
| | Slate number = 0000 0001, indicating that this candidate space location is linked to |
| | all candidates sharing this same slate number. |
| I | CE = 1, indicating that this candidate space location is associated with a candidate for |
| | office. Setting this bit also means that the button associated with this candidate space |
| | location is active, that is able to be selected by voters during the election. |
| | Slate number = 0000 0010, indicating that this candidate space location is linked to |
| | all candidates sharing this same slate number. |
| J | CE = 1, indicating that this candidate space location is associated with a candidate for |
| | office. Setting this bit also means that the button associated with this candidate space |
| | location is active, that is able to be selected by voters during the election. |
| K | CE = 1, indicating that this candidate space location is associated with a candidate for |
| | office. Setting this bit also means that the button associated with this candidate space |
| | location is active, that is able to be selected by voters during the election. |
| | WI = 1, indicated that this candidate space location is associated with a write in |
| | candidate. |
| L | OF = 1, indicating the start of an office or a question on the printed ballot card. |
| | VF byte = 0000 0001, indicating that a voter may select only one response to this |
| | question. |
| M | No bits enabled indicating a blank space or continuation from a previous line on the |
| | printed ballot card. |
| N | Q = 1, indicating that this candidate space location is associated with a response to a |
| | question that the voter may select (i.e., select all democratic candidates). Setting this |
| | bit also means that the button and indicator light associated with this candidate space |
| | location is active, that is able to be selected by voters during the election. |
| O | Q = 1, indicating that this candidate space location is associated with a response to a |
| | question that the voter may select (i.e., select all democratic candidates). Setting this |
| | bit also means that the button and indicator light associated with this candidate space |
| | location is active, that is able to be selected by voters during the election. |

Once the bits are set, the printed ballot card should be sealed within the ballot card holder in order to prevent removal of the printed ballot card until after the voting is completed. As described below, the embedded processor uses these set up bits during the election in order to validate selections, prevent an over-vote, and control the voting process.

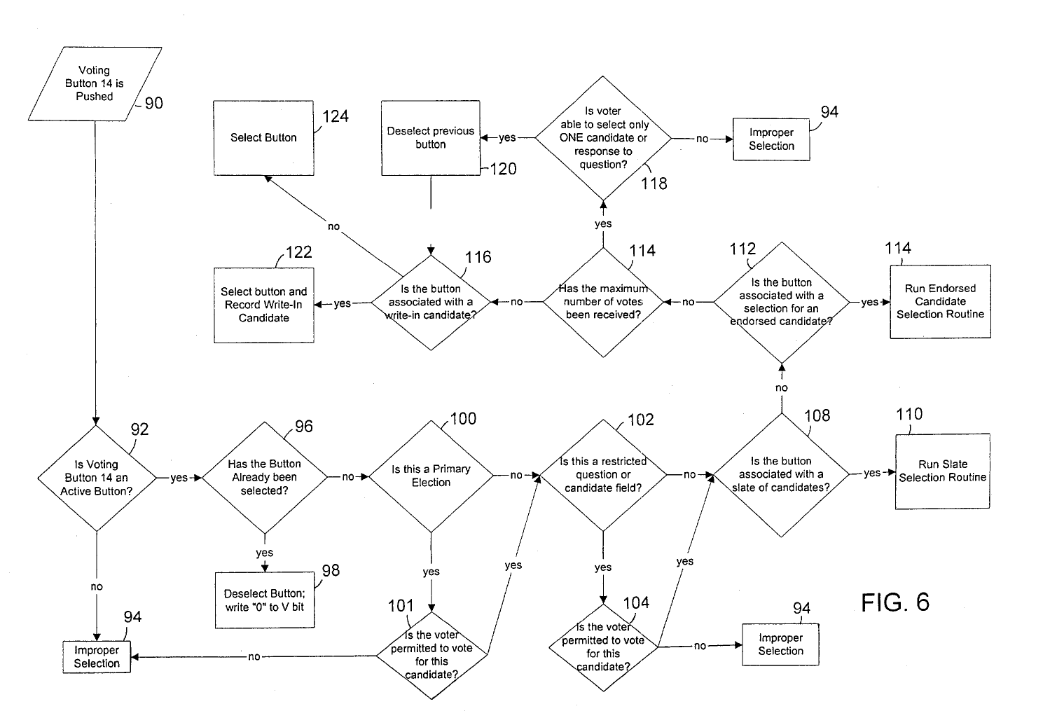

In operation, a voter enters a voting station containing a set up voting machine with a printed ballot card sealed in place. When the voter makes a selection by pressing one of the voting buttons, the multiplexor/demultiplexor 40a (shown in FIG. 2) relays the information to the embedded processor. The set up routine stored on ROM 62 verifies that the button selected by the voter is a proper selection according to the algorithm illustrated in FIG. 6.

As shown in FIG. 6, when the embedded processor receives a signal indicating that a button has been pressed (90), the embedded processor then first checks the bits associated with the candidate space location of the button which was pressed to ensure that the button is within an active candidate space location (92). To do this, the embedded processor checks to ensure that either the CE (candidate enable bit) or Q (question enable) bit is enabled. If neither of these bits is enabled, then the button that the voter has pressed is not associated with an active candidate space location and the embedded processor will not illuminate the indicator light (94).

If either the CE or Q bit is enabled, then the embedded processor will then check to see if the button has previously been selection by the voter by reading the V bit (96). If the bit is a “1”, then the button has been previously pushed by the voter and the embedded processor will deselect the button by writing a “0” to the V bit for that candidate location space and extinguishing the indicator light (98). If the V bit is a “0”, then the embedded processor will proceed to run a number of checks on the other candidate space locations within the candidate or question field in which the selection was made. The candidate or question field is the group of candidate space locations which correspond to an office up for election on the ballot card or a question posed to the voters on the ballot card. For example, referring to FIG. 5, the candidate or question fields are A-E (vote for all democratic or republican candidates), G-K (vote for school board members), and L-O (vote on property tax).

The embedded processor will next check to see if the election is a primary by checking the PE bit in the candidate space location of the button that was selected (100). If the PE bit is enabled, then it is a primary election and voters registered with a political party may only vote in their party's primary election. The embedded processor will check the voters' political party (which is entered by voting officials) against the primary byte in the candidate space location to see if they match (101). If they do not match, then the selection is improper and the indicator light is not illuminated and a “1” is not written to the V bit (94). If they do match, then the embedded processor runs additional checks to see if the selection is valid. In other embodiments the embedded processor may be programmed to permit independent voters to participate in a primary election. In this embodiment, the embedded processor would read the political party of the candidate which the voter makes his or her selection and then locks to voter into the primary election for that political party and prevents the voter from making any selections from a different party.

After running the primary election check (100), if either the election is not a primary election or the election is a primary election and the voter is permitted to vote for the candidate selected, the embedded processor then checks to see if this is a restricted candidate or question (102). The embedded processor reads the ROF, RQ, DRQ and DROF bits of the candidate space location of the button that was selected to determine if the field is restricted. If it is (i.e., ROF=1 and DROF=0, or RQ=1 and DRQ=0), then the embedded processor checks to see if the voter is permitted to vote for the restricted candidate or question (104). If the voter is not able to vote for the restricted candidate or question, then the selection is not proper and the embedded processor does not illuminate a indicator light or write a “1” to the V bit (94).

If either the candidate or question field is not a restricted candidate or question or if it is restricted but the voter is allowed to vote in the restricted question or candidate field, then the embedded processor checks to see is the button selected is associated with a slate of candidates by reading the SE bit of the candidate space location of the button that was selected (108). If the SE bit is enabled, the embedded processor runs a slate selection routine (110) to automatically select all candidates matching the slate identifier of the button which was selected by the voter. The slate selection routine (110) checks to ensure that each of the votes on the slate is a valid selection and then will select all valid selections on the slate.

If the SE bit is not enabled, then the button selected by the voter is not associated with a vote for a slate of candidates and the processor moves on to check whether the button selected is associated with a vote for an endorsed candidate (112). The embedded processor checks the ECE bit in the candidate space location of the button that was selected to see if the button pressed by the voter is associated with an endorsement vote. If the ECE bit is enabled then the embedded processor runs an endorsed candidate selection routine (114) to automatically select all candidates matching the endorsed candidate identifier. The endorsed candidate selection routine (114) will check to ensure that each of the selections for the endorsed candidates is a valid selection and then will select all valid selections within the group of endorsed candidates.

If the ECE is not enabled, then the button selected by the voter is not associated with a vote for one or more endorsed candidates, and the embedded processor continues to validate the voter's selection by checking to see if the maximum number of votes have been received in the candidate or question field (114). The embedded processor reads the VF byte in the first candidate space location in the candidate or question field in which the voter pressed the button to see the maximum number of votes the voter may cast for this particular office or question in the election. The embedded processor then reads the V bit in each of the active candidate space locations in the candidate or question field (i.e., those candidate space locations in the field which have either the CE or Q bit enabled). The embedded processor counts the number of V bits that have been enabled in each of the active candidate space locations in the candidate or question field and compares the total to the value of the VF byte at the first candidate space location in the field. If the total number of V bits set to “1” in the active candidate space locations in the field is less than VF, then the maximum number of votes has not been received and the embedded processor then moves on to check to see if the button selected by the voter is associated with a write-in candidate (116).

If, however, the total number of V bits in the active candidate space locations in the candidate or question field is not less than VF, then the maximum number of votes has been received. In this case, the embedded processor will then check to see if the voter is only able to select one candidate or response to a question in the candidate or question field by to see if the value of the VF byte is set to one (i.e., VF=0000 0001) (118). If it is, then the embedded processor will deselect the other previous button pressed by the voter in the candidate or question field (120). The embedded processor deselects a button by extinguishing the indicator light associated with the button and writing a “0” to the V bit in the candidate space location associated with the button. After deselecting the previous button (120), the embedded processor then checks to see if the current button selected is associated with a write-in candidate (116). If the embedded processor determines that the maximum number of selections a voter may make in a candidate or question field is greater than one and the maximum number of selections has already been made by the voter prior to pressing the current button, then the voter's selection is an improper selection and the embedded processor will not select or deselect any buttons (94).

If the maximum number of votes has not been received (or if the maximum number ahs been received and the embedded processor has deselected the previously-selected button (120)), then the embedded processor checks the WI bit of the candidate space location associated with the button selected by the voter (116). If the bit is set to “1”, then the embedded processor illuminates the indicator light associated with the button, writes a “1” to the V bit in the candidate space location associated with the button, and records the voter's write in vote on the electrostatic write-in device (122). If the WI bit is set to “0”, then the embedded processor illuminates the indicator light associated with the button and writes a “1” to the V bit in the candidate space location associated with the button (124).

After the voter has completed making his or her selections, the voter finalizes the voting process by pressing the record votes button 22 (shown in FIG. 1). When the voter presses this button, the embedded processor reads all of the V bits in the active candidate space locations (i.e., those candidate space locations which have a CE or Q bit enabled). For each “1” read in the V bit location, the embedded processor will add a one to the bytes containing the total number of votes received for that candidate space location (shown in FIG. 4) and then rewrite a “0” in the V bit location. After recording the votes, the embedded processor then downloads the vote count to an external device (e.g. election control panel 71) maintained by the election officials via the UART 70 (shown in FIG. 3). The embedded processor also runs a systems check after each voter to ensure that all components (e.g., voting modules, printer, display, electrostatic input device) and sub-components (e.g., buttons and indicator lights) are functioning properly. If they systems check indicates that all components and sub-components are functioning properly, the voting machine is ready for the next voter. If the systems check reveals a faulty component or sub-component, this information is relayed to the election control panel and the voting machine prevents further voting until the problem is fixed.

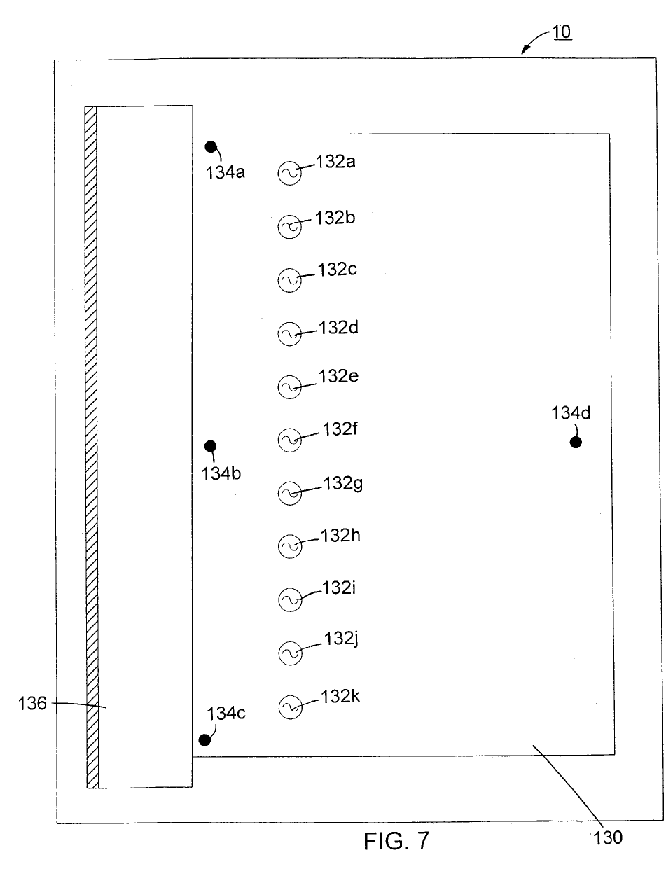

As shown in FIG. 7, another embodiment of voting machine 10 includes a surface 130 having an electrostatic point embedded in each candidate space location 132a-132k. A printed ballot card (not shown) may be placed on top of the surface 130 and the electrostatic points 132a-132k. The surface 130 of the voting machine 10 includes four pegs 134a-134d which match with four corresponding holes on the printed ballot card in order to ensure that the printed ballot card is properly aligned when it is placed on the surface 130 of the voting machine 10. A clip 136 mounted to the voting machine further secures the printed ballot card in place.

Once the printed ballot card secured in placed on top of the surface 130 of the voting machine 10, the voter uses a pen to mark the ballot. As the voter marks the ballot the electrostatic points on the surface 132a-132k of the voting machine 10 sense the voter's mark on the ballot and record the vote. A voter may write-in a candidate by marking by marking a space on the printed ballot card that indicates a desire to write-in a vote. The electrostatic point aligned with this point is set up to tell the embedded processor that a write in vote is being entered for the particular office. The voter then writes in his or her vote on a piece of paper or via an electronic input device (e.g., a keyboard, electrostatic input device, touch screen).

A number of embodiments of the invention have been described. Nevertheless, it will be understood that various modifications may be made without departing from the spirit and scope of the invention. For example, rather than using voting buttons as illustrated above, the voting machine may use switches, touch-screens or pad, keys, or other input devices to input a voter's selection. Accordingly, other embodiments are within the scope of the following claims.

What is claimed is:

1. A voting machine comprising:
a voter selection module configured to display a ballot, the voter selection module comprising:
a plurality of distinct physical locations, wherein each physical location is associated with a portion of a ballot displayed on the voter selection module; and
a plurality of input devices, at least one input device associated with each of the physical locations; and
a memory device configured with a plurality of blocks of memory, each block of memory mapped to a separate physical location, wherein each block of memory contain data which indicate information about the portion of a ballot located at the corresponding physical location.

2. The voting machine of claim 1 wherein each block of memory contain data which indicate whether the portion of a ballot located at the corresponding physical location contains the name of a candidate.

3. The voting machine of claim 1 wherein the plurality of input devices comprises a surface having a plurality of electrostatic points.

4. The voting machine of claim 1 wherein the plurality of input devices comprises a plurality of buttons.

5. The voting machine of claim 1 further comprising:
a processor removably connected to the voter selection module, the processor configured to receive input from one or more the plurality of input devices indicating a voter selection and read the data located at the block of memory associated with the selected physical location to verity validity of the selection.

6. The voting machine of claim 5 wherein the processor further comprises:
a central processing unit in communication with the memory device; and
a second memory device containing an operating system, the storage device in communication with the central processing unit.

7. The voting machine of claim 6 further comprising:
a plurality of voter selection modules, wherein each voter selection module is configured to be hot-swappable.

8. The voting machine of claim 6 wherein the memory device is Random Access Memory.

9. The voting machine of claim 6 wherein the second memory device is Read-Only Memory.

10. The voting machine of claim 5, wherein the voter selection module further comprises:
a plurality of indicator lights, at least one indicator light adjacent to each of the input devices, wherein each of the indicator light is configured to illuminate when the button is selected by a voter and the processor has verified that the input is valid.

11. The voting machine of claim 1 further comprising:
one or more input devices configured to permit a user to set one or more bits in each block of memory according to a portion of a ballot displayed at the corresponding physical location.

12. The voting machine of claim 11, wherein the one or more input devices configured to permit a user to set one or more bits in each block of memory comprises a touch-screen display.

13. The voting machine of claim 11, wherein the one or more input devices configured to permit a user to set one or more bits in each block of memory comprises a display and a keyboard.

14. The voting machine of claim 11, wherein the user sets one or more bits in each block of memory via a graphical user interface.

15. The voting machine of claim 6 wherein the processor further comprises:
a second central processing unit in communication with the first central processing unit and the first and second memory devices.

16. The voting machine of claim 1, wherein the voter selection module further comprises a ballot card holder configured to hold a paper ballot card.

17. The voting machine of claim 1, wherein the voter selection module further includes at least one display configured to electronically display a ballot.

18. The voting machine of claim 17, further comprising a switch configured to change the language of the ballot on at least one of the electronic displays.

19. The voting machine of claim 5, further comprising a printer connected to the processor.

20. The voting machine of claim 19, wherein the printer is configured to print out a ballot for a write-in candidate.

21. The voting machine of claim 5, further comprising an electrostatic input device connected to the processor and configured to record images of write-in votes.

22. The voting machine of claim 21, wherein the processor is configured to convert written text input into the electrostatic input device into ASCII text.

23. The voting machine of claim 5, further comprising a second input device in communication with the processor and configured to cause the processor to record a voter's selections in the memory device when the processor receives a signal from the second input device.

24. The voting machine of claim 23, wherein the second input device is a button located on the voting machine and is configured to cause the processor to record a voter's selections when the button is pressed.

25. The voting machine of claim 23, wherein the memory device containing the voter's recorded votes is encapsulated in a container.

26. The voting machine of claim 1, further comprising a main power supply and a back-up power supply and configured to provide electrical power to the voting machine.

27. The voting machine of claim 26 wherein the main power supply is an AC/DC converter and the back-up power supply is a battery.

28. The voting machine of claim 6, further comprising a remote election control panel and wherein the processor further includes a communications device in communication with the remote election control panel.

29. The voting machine of claim 28, wherein vote totals are uploaded to the election control panel by the processor.

30. The voting machine of claim 28, wherein the voter information is downloaded to the processor from the election control panel before a voter begins the voting process.

31. The voting machine of claim 11 wherein the one or more input devices are configured to permit a user to input voter information before a voter begins the voting process.

32. The voting machine of claim 31 wherein the input comprises voter political party information.

33. A method of automated vote counting, the method comprising:
providing a ballot;
providing a plurality of vote selection devices within a voting terminal;
providing a processor, the processor having a central processing unit and a storage device having a memory; and
associating each one of the plurality of vote selection devices with a unique physical location on the ballot and a unique block of memory within the storage device, each associated vote selection device, physical location on the ballot and block of memory forming a candidate space location, and wherein the blocks of memory include a plurality of bits which hold information about their respective candidate space locations.

34. The method of claim 33 wherein the storage device is Random Access Memory.

35. The method of claim 33 wherein the vote selection device is a switch.

36. The method of claim 33, further comprising:
receiving a vote selection from an input device by a user;
identifying the input device from which the vote selection was received; and
validating the user's selection by reading the block of memory associated with the vote selection device from which the vote selection was received.

37. The method of claim 36, further comprising:
validating the user's selection by reading a plurality of blocks of memory associated with a plurality of candidate space locations.

38. The method of claim 36, further comprising:
determining if the user's selection is for a write in candidate; and
receiving a write in vote from an input device if the user's selection is for a write in candidate.

39. The method of claim 36, further comprising:
receiving input from the user indicating completion of the voting process; and
in response to the input, recording all of the user's selections as votes within the storage device.

40. The method of claim 39, further comprising:
providing a printer; and
printing out the user's finalized votes.

41. A method for automated vote counting comprising:
associating a physical location on a voting machine with a block of memory, wherein the physical location on the voting machine is configured to display ballot information; and
assigning a definition to one or more bits within the block of memory such that the one or more bits indicate data about ballot information displayed at the associated physical location on the voting machine.

42. The method of claim 41, further comprising:
displaying ballot information in the physical location of the voting machine; and
setting one or more bits within the block of memory according to the ballot information located at the associated physical location.

43. The method of claim 41, further comprising:
providing a first voting module and a second voting module;
associating a first set of physical locations on the first voting module with a separate block of memory, wherein each physical location on the first voting module is configured to display a portion of ballot of information; and
associating a second set of physical locations on the second voting module with a separate block of memory, wherein each physical location on the second voting module is configured to display a portion of ballot of information.

44. The method of claim 43 further comprising:
detecting a failure in one of the voting modules; and
replacing the failed voting module with a third voting module without rebooting the voting machine.

45. The method of claim 41, wherein the step of assigning a definition further comprises:
defining one bit within the block of memory to indicate whether the ballot information located at the associated physical location contains a candidate's name.

46. The method of claim 42, further comprising:
associating the physical location with a selection device; and
receiving an input from a selection device associated with the physical location, wherein the input indicates a voter has made a selection based on the ballot information displayed at the associated physical location.

47. The method of claim 46, further comprising:
reading the one or more bits of data within the block of memory associated with the physical location which was selected; and
based on the one or more bits of data within the block of memory associated with the physical locations which was selected, verifying that the selection is a valid selection.

48. The method of claim 47, further comprising:
if the selection is a valid selection, then illuminating an indicator light associated with the physical location which was selected.

49. The method of claim 47, further comprising:
receiving an input indicating a completion of a voter's selections; and
in response to receiving an input indicating a completion of a voter's selections, recording a vote in a portion of the block of memory associated with the selected physical location.

50. The method of claim 49, further comprising:
in response to receiving an input indicating a completion of a voter's selections, printing the voter's selections.

51. The method of claim 41 further comprising:
providing a primary power supply and a backup power supply;
detecting a power failure from the main power supply; and
switching to the backup power supply.

52. The method of claim 41 further comprising:
receiving an input indicating information about a voter; and
storing the voter information input.

53. The method of claim 52 further comprising:
reading the stored voter information; and
verifying the validity of a voter selection based on the stored voter information.

54. The method of claim 41 further comprising:
transmitting vote totals to an external terminal.
